(19) United States
(12) Patent Application Publication
(10) Pub. No.: US 2019/0322860 A1
(43) Pub. Date: Oct. 24, 2019

(54) CATIONICALLY CURABLE SEALANT COMPOSITION

(71) Applicant: Henkel AG & Co. KGaA, Duesseldorf (DE)

(72) Inventors: XiuZhen Wang, Shanghai (CN); Minghai Wang, Shanghai (CN); Lei Li, Jiangsu (CN)

(21) Appl. No.: 16/458,256

(22) Filed: Jul. 1, 2019

Related U.S. Application Data
(63) Continuation of application No. PCT/CN2016/112924, filed on Dec. 29, 2016.

(51) Int. Cl. C08L 63/04; G02F 1/1339; C08K 5/03; G02F 1/1341

(52) U.S. Cl. CPC C08L 63/04; G02F 1/1339; G02F 2001/13415; G02F 1/1341; C08K 5/03

(57) ABSTRACT

This invention relates to a cationically curable sealant composition for liquid crystal sealing. In particular, the invention relates to a cationically curable sealant composition suitable to be used in one drop filling (ODF) process for manufacturing liquid crystal display device without the concern of moisture resistance and liquid crystal penetration.

The cationically curable sealant composition comprises an epoxy resin selected from phenol novolac epoxy resin, dicyclopentadiene type epoxy resin, and combination thereof; and a diaryliodonium fluorine photoinitiator represented by formula (1),

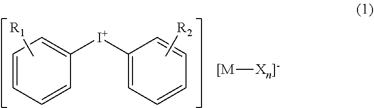

wherein R₁ and R₂ represent each independently hydrogen, an optionally substituted alkyl, an optionally substituted cycloalkyl, an optionally substituted alkoxy, or carboxyl or its ester, M represents As, P, Sb or B, X represents F or C₆F₅, and n is 4 or 6.

In addition, the present invention relates to a process of producing a liquid crystal display having a liquid crystal layer between a first substrate and a second substrate, comprising steps of: applying a cationically curable sealant composition on a sealing region at a periphery of a surface of the first substrate; radiation curing the composition, and obtaining a partially cured product; dropping liquid crystal on a central area encircled by the sealing region of the surface of the first substrate or the corresponding area of the second substrate, and forming the liquid crystal layer; overlaying the second substrate on the first substrate; and radiation curing the partially cured product.

### TECHNICAL FIELD

This invention relates to a cationically curable sealant composition for liquid crystal sealing. In particular, the invention relates to a cationically curable sealant composition suitable to be used in one drop filling (ODF) process for manufacturing liquid crystal display device without the concern of moisture resistance and liquid crystal penetration.

### BACKGROUND OF THE INVENTION

Liquid crystal display (LCD) panels having the characteristics of being light-weight and high-definition have been widely used as display panels for a variety of apparatuses including cell phones and TVs. Conventionally, the process for producing a LCD panel is called a one-drop-filling (ODF) process comprising applying a sealant on a substrate having an electrode pattern and an alignment film under vacuum condition, dropping liquid crystal (LC) on the substrate having the sealant applied thereon, joining opposite facing substrates to each other under vacuum, then releasing the vacuum and performing ultraviolet (UV) irradiation or UV irradiation plus heating to cure the sealant and thereby producing a LCD cell.

Recently, development of LCD has been more towards the direction of “slim border” or “narrow bezel” design. Among several ways to achieve this goal, one is the use of a narrow width of the sealant. However, a thinner line of sealant creates more challenge with typical ODF process due to the fact that the process needs to meet very high reliability to prevent the liquid crystal material from penetration and contamination. The requirement of low liquid crystal contamination is particularly critical to ODF sealant products. No contamination is required to occur before and after the radiation curing process.

The widely used sealant used in ODF process are normally UV and thermal dual curable types, in order to decrease contamination of the liquid crystal and confer to liquid crystal displays high-quality images having little color irregularity. Efforts have been made to develop resins having high polarity and low compatibility with the liquid crystal, and frequently used options are epoxy and/or (meth)acrylate resins having hydroxyl group or having a hydrogen bonding functional group. However, presence of these groups will decrease water barrier property of the cured materials, and once the LCDs are exposed to the environment where the temperature or humidity is high, frame Mura phenomenon will take place and reliability of the display will be reduced.

There have been several attempts to improve the moisture resistance of the cured sealant product.

For example, JP2013015769A discloses to use spherical inorganic fillers having different particle diameters in a sealant composition having an excellent adhesiveness and moisture-resistant reliability. However, the mixture of fillers may cause LC penetration issue, and may have an adverse effect upon the dispensing linearity of the sealant.

JP2011090213A discloses a sealant composition containing a curable resin having an epoxy group and a (meth)acryl group or their mixtures. It is reported that such sealant has an excellent moisture resistance and hardly induces contamination issue. However, the sealant composition may not prevent liquid crystal from penetrating in the thermal curing process, and its water barrier property is not good enough under severe conditions.

In addition, JP2009134293A discloses to use multifunctional (meth)acrylates in the sealant composition to achieve an excellent moisture resistance. The use of such resins may cause very low VHR (Voltage Holding Ratio) and results in frame Mura problems.

Thus, there is still a need for a cationically curable sealant composition that can improve the moisture resistance and meanwhile maintain an excellent performance in LC penetration.

### SUMMARY OF THE INVENTION

The present invention provides a cationically curable sealant composition, comprising an epoxy resin selected from phenol novolac epoxy resin, dicyclopentadiene type epoxy resin, and combination thereof; and a diaryliodonium fluorine photoinitiator represented by formula (1),

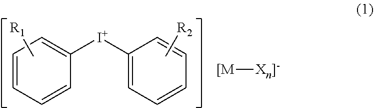

wherein R₁ and R₂ represent each independently hydrogen, an optionally substituted alkyl, an optionally substituted cycloalkyl, an optionally substituted alkoxy, or carboxyl or its ester, M represents As, P, Sb or B, X represents F or C₆F₅, and n is 4 or 6.

The present invention also provides a cured sealant product obtained from the cationically curable sealant composition according to the present invention.

Furthermore, the present invention provides a process of producing a liquid crystal display having a liquid crystal layer between a first substrate and a second substrate, comprising steps of:

applying a cationically curable sealant composition on a sealing region at a periphery of a surface of the first substrate;

radiation curing the composition, and obtaining a partially cured product;

dropping liquid crystal on a central area encircled by the sealing region of the surface of the first substrate or the corresponding area of the second substrate, and forming the liquid crystal layer;

overlaying the second substrate on the first substrate; and

radiation curing the partially cured product.

### BRIEF DESCRIPTION OF THE FIGURES

FIG. 1 illustrates a flow chart of the ODF process according to the present invention.

FIG. 2 illustrates the dispensing pattern of the sealant composition on the liquid crystal display cell used in the LC penetration evaluation.

FIGS. 3(a) and (b) illustrates the top view images of LC cells produced in Example 3 and Comparative Example 1 taken by microscope immediately after preparation.

FIGS. 4(a) and (b) illustrates the top view images of LC cells produced in Example 3 and Comparative Example 1 taken by microscope with polarizer after prepared for 1 month.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

In one aspect, the present invention provides a cationically curable sealant composition for liquid crystal sealing, comprising an epoxy resin selected from phenol novolac epoxy resin, dicyclopentadiene type epoxy resin, and combination thereof; and a diaryliodonium fluorine photoinitiator represented by formula (1),

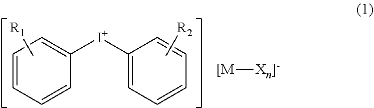

wherein R₁ and R₂ represent each independently hydrogen, an optionally substituted alkyl, an optionally substituted cycloalkyl, an optionally substituted alkoxy, or carboxyl or its ester, M represents As, P, Sb or B, X represents F or C₆F₅, and n is 4 or 6.

It has been surprisingly found that the cationically curable sealant composition according to the present invention provides an improved moisture barrier property after curing, and meanwhile prevents the LC penetration in ODF process.

### Epoxy Resin

According to the present invention, the epoxy resin suitable to be used in the sealant composition for ODF process, especially so called “UV B-stage” ODF process is selected from phenol novolac epoxy resin, dicyclopentadiene type epoxy resin, and combination thereof.

The phenol novolac epoxy resin useful in the present invention may be represented by formula (2),

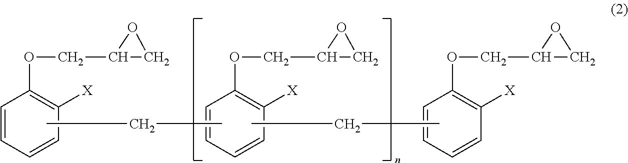

wherein X represents hydrogen or methyl, and n has an average value of about 0.1 to about 3, preferably about 0.2 to about 2.0.

When X is hydrogen, the phenol novolac epoxy resin is commonly referred as epoxy phenol novolac (EPN). When X is methyl, the phenol novolac epoxy resin is commonly referred as epoxy cresol novolac (ECN). In one embodiment, the phenol novolac epoxy resin is selected from EPN, ECN, and combination thereof.

If the phenol novolac epoxy resin has a very low viscosity, it is easy to cause LC penetration problems during or after the ODF process. Preferably, the phenol novolac epoxy resin has a number average molecular weight of about 300 to about 1,000 g/mol, and more preferably about 400 to about 850 g/mol, as determined by gel permeation chromatography (GPC) method. In addition, the phenol novolac epoxy resin preferably has a viscosity of about 500 cps to about 100,000 cps at 52° C., and more preferably about 500 cps to about 50,000 cps at 52° C.

Examples of such phenol novolac epoxy resins include but not limited to EPALLOY 8250, EPALLOY 8280, EPALLOY 8330, EPALLOY 8350, EPALLOY 8370 from CVC Thermoset Specialties; Araldite EPN 9850, Araldite EPN 9880, Araldite EPN 9881,PY 307-1, Araldite EPN 1139, Araldite EPN 1179, Araldite EPN 1180 from Huntsman Corporation; D.E.N.425, D.E.N.431, D.E.N.438, D.E.N.438L, D.E.N.439 from Dow Chemical Company; VP 3680, Struktol Polydis 3680 S from Struktol Company of America; YDPN-631, YDPN-636, YDPN-637, YDPN-638, YDPN-641, YDPN-644 from KUKDO Chemical; EPON HPT 1050, EPON 154, EPON SU-2.5, EPON SU-3 from Hexion Specialty Chemicals, Inc; EPICLON N-730-S, EPICLON N-740 from DIC Corporation, and the like.

The dicyclopentadiene (DCPD) type epoxy resin useful in the present invention may be represented by formula (3),

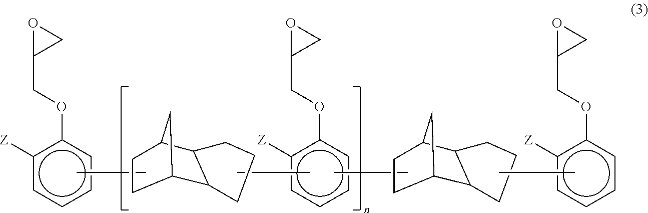

wherein Z represent hydrogen or a C₁₋₆ alkyl, such as methyl, ethyle, or isopropyl, and n has a value of 0 to about 2. Preferably, the DCPD type epoxy resin is in the form of solid.

Examples of such DCPD type epoxy resins include but not limited to HP-7200, HP-7200L, HP-7200H, HP-7200HH, HP-7200-EU from Dainippon Ink & Chemicals, Inc; KDCP-100, KDCP-150, KDCP-200 from Kukdo Chemical Co. Ltd.; Tactix 556, Tactix 756 from Huntsman Corporation; DCPD Phenol Epoxy and DCPD-BPA Novolac & Epoxy from Kolon Industries, and the like.

According to the present invention, phenol novolac epoxy resin and/or dicyclopentadiene type epoxy resin is used as the main resin matrix in the cationically curable sealant composition. The incorporation of such resins is very effective to increase the crosslink density or increase the glass transition temperature of the sealant, and improves its moisture resistance property as well. Also, it is useful to adjust the viscosity of a one-drop-filling LCD sealant to a required level.

### Diaryliodonium Fluorine Photoinitiator

Diaryliodonium fluorine photoinitiators are a specific type of cationic photoinitiators which can produce a proton acid or a Lewis acid by exposure under UV lamps, generate positive ions active center, thereby initiate the crosslinking and polymerizing reaction of cationic polymerizable compounds such as the epoxy resins and other additional component used in the sealant composition of the present invention.

The diaryliodonium fluorine photoinitiator useful in the present invention may be represented by formula (1)

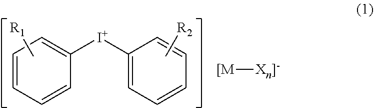

wherein R₁ and R₂ represent each independently hydrogen, an optionally substituted alkyl, preferably optionally substituted C₁₋₁₆ alkyl, an optionally substituted cycloalkyl, preferably optionally substituted C₁₋₁₆ cycloalkyl, an optionally substituted alkoxy, preferably optionally substituted C₁₋₁₆ alkoxy, or carboxyl or its ester, M represents As, P, Sb or B, X represents F or C₆F₅, and n is 4 or 6.

In one embodiment, R₁ is methyl, R₂ is methyipropyl, M is P, X is F and n is 6. In another embodiment, R₁ and R₂ are dodecyl, M is Sb, X is F and n is 6. In yet another embodiment, R₁ is methyl, R₂ is isopropyl, M is B, X is C₆F₅ and n is 4. In yet another embodiment, R₁ is hydrogen, R₂ is 2-hydroxyl-tetradecyloxy, M is Sb, X is F and n is 6.

Examples of commercially available diaryliodonium fluorine photoinitiator include, but not limited to: diaryliodonium fluorine antimonate (such as SilForce UV 9380 C from Momentive Performance Materials Inc., PC-2506, PC-2508, PC-2509 and PC-2544 from Polyset Company, Inc), diaryliodonium fluorine phosphate (such as IRGACURE 250 from Ciba Specialty Chemicals Inc., Omnicat 440, Omnicat 445 from iGM WOFE Shanghai), diaryliodonium fluorine Borate (such as Rhodorsil Photoinitiator 2074 from RHODIA CHIMIE).

The diaryliodonium fluorine photoinitiator used in the cationically curable sealant composition is in an amount of about 0.01 to about 5 parts by weight, and preferably about 0.1 to about 2 parts by weight, based on 100 parts by weight of the total amount of cationically curable sealant composition.

The cationically curable sealant composition may comprise one or more additives. Additives comprised in the cationically curable sealant composition according to the present invention are those conventionally used in the art of cationically curable sealants to satisfy different properties and meet specific application requirements. The additives can optionally be included from 0% by weight to about 20% by weight in the cationically curable sealant composition of the present invention. Such additives include, for example, property modifier, free radical photo initiator, thermal curing agents, organic or inorganic filler, thixotropic agent, silane coupling agent, diluent, modifier, coloring agent such as pigment and dye, surfactant, preservative-stabilizer, plasticizer, lubricant, defoamer, leveling agent, which may be incorporated in minor or larger amounts into the adhesive formulation, singly or in combination, depending on the purpose. In particular, the composition preferably comprises an additive selected from the group consisting of property modified resin, organic or inorganic filler, and a silane coupling agent.

The property modifier may be other cationically curable resins. Examples include but not limited to cyclic ether (other than phenol novolac epoxy resin, dicyclopentadiene type epoxy resin), vinyl ether, polyol, episulfide, cyclic acetals, and mixtures thereof.

Among the cyclic ethers, bisphenol A epoxy resins are not preferred as the moisture resistance may be deteriorated if a significant amount of bisphenol A epoxy resin is contained in the sealant composition. In one embodiment, the cationically curable sealant composition according to the present invention essentially comprises no bisphenol A epoxy resin, for example, comprises bisphenol A epoxy resin in an amount of less than about 5% by weight, or less than about 3% by weight, or less than about 1% by weight, or less than about 0.5% by weight, or less than about 0.1% by weight, based on the total amount of all components of the sealant composition. Preferably, the sealant composition according to the present invention comprises no bisphenol A epoxy resin.

In another aspect, the present invention also concerns a cured sealant product obtained from the cationically curable sealant composition according to the present invention. The cured sealant product according to the present invention has a low water vapor transmission rate (WVTR), preferably of about 15 g/(m²·day) or less, more preferably of about 10 g/(m²·day) or less, at 50° C. and 100% relative humidity.

While the choice of components, order of addition, and addition rate can be left to the skilled practitioner in sealant art. Generally, the cationically curable sealant composition can be obtained by mixing the aforementioned each component by means of, for example, a mixer such as a speedmixer, a stirrer having stirring blades, a three roll mill or the combination thereof.

Not bound by any theory, the combined use of the phenol novolac epoxy resin and/or dicyclopentadiene type epoxy resin, as well as the diaryliodonium fluorine photoinitiator in the cationically curable sealant composition results in an excellent resistance against moisture even under severe condition and meanwhile maintaining sufficient LC penetration resistance by means of ODF process, especially including UV B-stage.

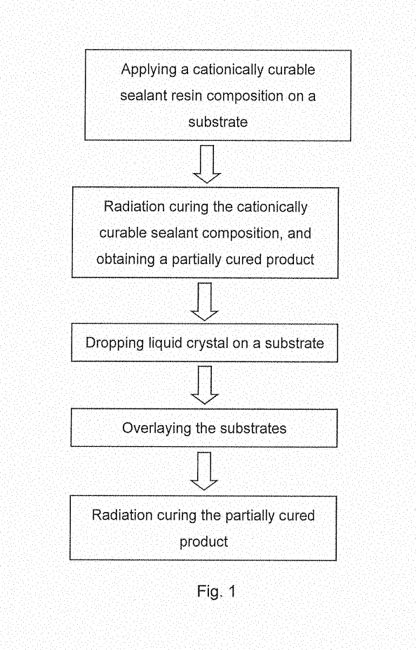

In another aspect, the present invention also provides a process of producing a liquid crystal display having a liquid crystal layer between a first substrate and a second substrate as shown in FIG. 1, comprising steps of:

applying a cationically curable sealant composition on a sealing region at a periphery of a surface of the first substrate;

radiation curing the composition, and obtaining a partially cured product;

dropping liquid crystal on a central area encircled by the sealing region of the surface of the first substrate or the corresponding area of the second substrate, and forming the liquid crystal layer;

overlaying the second substrate on the first substrate; and

radiation curing the partially cured product.

### Step 1)

In step 1) of the LCD producing process according to the present invention, a cationically curable sealant composition, preferably the cationically curable sealant composition according to the present invention is applied on the periphery portion of the surface of the first substrate so as to lap around the substrate circumference in a frame shape. The portion where the curable resin composition is applied in a frame shape is referred as a sealing region. The curable resin composition can be applied by a known method in the art such as screen printing and dispensing, preferably by dispensing.

The sealing region generally has a rectangular box shape, LCD display portion is formed in the sealing region inside the central zone. The sealing region on the outer surface of the substrate, electrode and the electrical/electronic parts installation space may be used if desired.

The first substrate and the second substrate used in the present invention are usually transparent glass substrates. Generally, transparent electrodes, active matrix elements (such as thin film transistor TFT), alignment film(s), a color filter and the like are formed on at least one of the opposed faces of the two substrates. These constitutions may be modified according to the type of LCD. The manufacturing method according to the present invention may be thought to be applied for any type of LCD.

In one embodiment, the cationically curable sealant composition according to the present invention is preferred to be used in step 1).

### Step 2)

In step 2), the curable resin composition applied on the first substrate was exposed to an actinic radiation so as to temporarily cure the composition and obtain a partially cured product. Such step preferably by UV radiation is so called “UV B-stage” defining a stage for pre-curing the sealant composition in order to make sealant surface tacky when partially cured, but not completely cured for the convenience of assembling two substrates together.

Although other type actinic radiation may be utilized, it is preferable to cure the sealant composition using ultraviolet, visible light or black light radiation. It is preferable for the radiation source to be substantially perpendicular to the substrate during curing. In one preferred embodiment, an ultraviolet radiation having a wavelength of about 200 to about 450 nm, preferably about 300 to about 450 nm is used to cure the sealant composition. In another preferred embodiment, the ultraviolet radiation applied to the composition has a radiation energy of less than about 3,000 mJ/cm², preferably about 50 mJ/cm² to about 1,000 mJ/cm2.

UV-A-emitting radiation sources (e.g. fluorescent tubes, LED technology or lamps, which are sold for example by Panacol-Elosol GmbH, Steinbach, Germany, under the name UV-H 254, Quick-Start UV 1200, UV-F 450, UV-P 250C, UV-P 280/6 or UV-F 900), high- or medium-pressure mercury vapor lamps, wherein the mercury vapour can be modified by doping with other elements such as gallium or iron, pulsed lamps (known as UV flash lamps) or halogen lamps, for example, are suitable as radiation sources for UV light in the specified wavelength range in step 2). Further suitable UV emitters or lamps also can be used in the present invention. The emitters can be installed in a fixed location, such that the item to be irradiated is moved past the radiation source by means of a mechanical device, or the emitters can be mobile and the item to be irradiated does not change its position during the temporary curing in step 2).

High- or medium-pressure mercury vapor lamps are preferably used in the method according to the invention in step 2), wherein the mercury vapor can be modified by doping with other elements such as gallium or iron.

Generally, the radiation time is preferably short, for example no longer than about 5 minutes, preferably no longer than about 3 minutes, more preferably no longer than about 1 minute.

### Step 3)

In step 3), the liquid crystal is then dropped onto the center area encircled by the sealing region in the frame shape on the surface of the first substrate or the corresponding area on the second substrate. “Corresponding area” means the area of the second substrate corresponding to the center area surrounded by the sealing region of the first substrate when the substrates are attached. Preferably, the liquid crystal is then dropped onto the center area encircled by the sealing region on the first substrate.

In step 4), a second substrate was superposed or overlaid on the first substrate so that the two substrates can be temporarily fixed by the partially cured product there between under reduced pressure, preferably under vacuum. The vacuum can be applied by conventional methods to achieve a vacuum degree of about 1.0 to about 3.0 Pa. The vacuum generation gap can be about 0.1 to about 0.5 mm.

In step 5), a second radiation curing preferably by UV radiation is applied to the partially cured resin product so as to achieve the final curing strength of the sealant, whereby the two substrates are finally fixed. The radiation curing may be achieved by the same way as that in step 2). In one preferred embodiment, an ultraviolet radiation having a wavelength of about 200 to about 450 nm, preferably about 300 to about 450 nm is used to cure the composition. In another preferred embodiment, the ultraviolet radiation applied to the sealant composition has radiation energy of about 100 mJ/cm² to about 10,000 mJ/cm², preferably about 500 mJ/cm² to about 5,000 mJ/cm². The radiation time is preferably short, for example no longer than about 5 minutes, preferably no longer than about 3 minutes, more preferably no longer than about 1 minute.

Optionally, the LCD producing process according to the present invention may comprise a thermal curing step after step 5) to increase the curing degree of the cured sealant product if it is also thermally curable.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Materials

Epalloy 8250 is the trade name of a phenol novolac epoxy resin commercially available from CVC Specialty Chemicals.

D.E.N.438 is the trade name of of an epoxy novolac resin commercially available from Dow Chemical Company.

YX8040, YX8034 and YX8000 are trade names of hydrogenated bisphenol A epoxy resins commercially available from Japan Epoxy Resins Co., Ltd.

HP7200 is the trade name of a dicyclopentadiene type epoxy resin is commercially available from Dainippon Ink & Chemicals, Inc.

IRGACURE 250 is the trade name of a diaryliodonium fluorine photoinitiator commercially available from Ciba Specialty Chemicals Corp.

SilForce UV 9380 C is the trade name of a diaryliodonium fluorine photoinitiator commercially available from Momentive Performance Materials Inc.

Rhodorsil photoinitiator 2074 is the trade name of a diaryliodonium fluorine photoinitiator commercially available from Rhodia Inc.

PC-2506 is the trade name of diaryliodonium fluorine photoinitiator commercially available from Polyset Company Inc.

### Preparation

The cationically curable sealant compositions having the formulations shown in Table 1 according to the present invention were prepared as Examples 1 to 6. The phenol novolac epoxy resin and/or dicyclopentadiene type epoxy resin were heated at a 60° C. to 70° C. oven to a melt state if the resins were semi-solid or solid. Then all components except the photoinitiator were weighed out and added into a jar and mixed by a speed mixer until completely dissolved, and then the photoinitiator was added into the same jar under yellow light. Make sure that the mixture was prevented to be exposed to white light by wrapping aluminium foil around the jar. The mixture was sufficiently stirred by a speed mixer so as to obtain a uniform sealant. After well dispersed, the mixture was filtrated through a 6.5 micron sieve, and then degassed properly. Afterwards, the sealant was transferred into a yellow syringe for use. Comparative examples 1 to 2 were also prepared in the same way except the epoxy resin used and weight ratio as also listed in Table 1.

### Tests and Evaluations

### (1) Moisture Resistance of the Cured Sealant

A test specimen with a size of 10 cm² and a thickness of 0.3 mm was produced by applying each sealant compositions of Examples 1 to 6 and Comparative Examples 1 and 2 thinly and evenly between two layers of PTFE on two glass plates. Each specimen was cured by UV light under 3000 mJ/cm².

After curing, the films of sealant were removed and placed in Mocon's machine PERMATRAN-W Model 3/61 for moisture resistance measurement. This test was carried out under the conditions of 50° C., 100% relative humidity, and 20 SCCM nitrogen flow rate for around 24 hours.

WVPC (Water Vapor Permeability Coefficient) was used to evaluate the moisture resistance of the sealant. The moisture resistance was considered as “Good” if the WVPC of the sealant was 15 gm·mil/[100 in²·day] or lower, “Fair” for the WVPC of 15 to 25 gm·mil/[100 in²·day], and “Poor” for the WVPC of larger than 25 gm·mil/[100 in²·day]. The test results are shown in Table 1.

### (2) LC Penetration Resistance

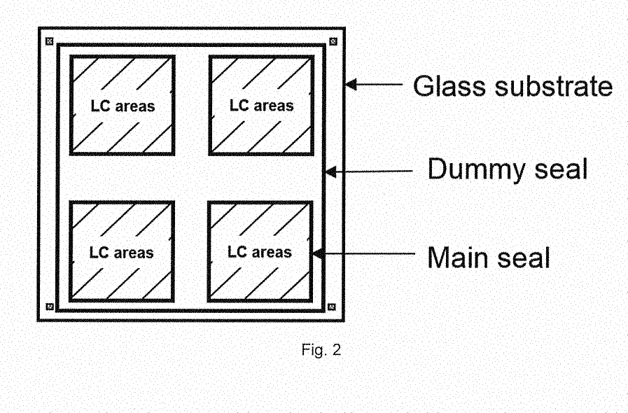

A polyimide (PI) layer was coated and then this layer was rubbed on two substrates made of glass (the first substrate and the second substrate) separately to keep liquid crystal oriented. On the second substrate, spacers were added to control the cell gap between two substrates and prevent the characteristic change of liquid crystal caused by the uneven thickness of the sealants. The obtained sealant was applied to the first glass substrate by a dispenser in such a manner so as to draw a rectangular frame. The sealant was dispensed in four square shapes as main seals surrounded by one closed big square which is called “dummy seal” as shown in FIG. 2. Then the sealant composition were exposed to UV rays with luminous intensity of 100 mJ/cm²to 300 mJ/cm², and thus the sealant composition was partially cured, making the surface of sealants tacky, but not completely cured. After the first curing step, fine droplets of a liquid crystal were applied on the entire face of the inside of the frame, then the two glass substrates were assembled together on a vacuum laminating machine under 3.0 Pa vacuum degree. The assembled liquid crystal display cell was idled for 4 minutes to observe by microscope whether LC penetration phenomenon occurred. Afterwards, the whole LCD cell was cured under 3000 mJ/cm² by high pressure mercury lamp, and the cell was placed under a microscope to check liquid crystal penetration performance.

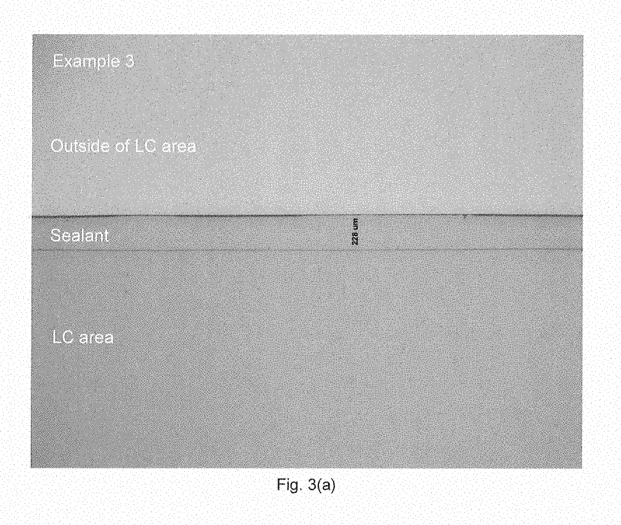

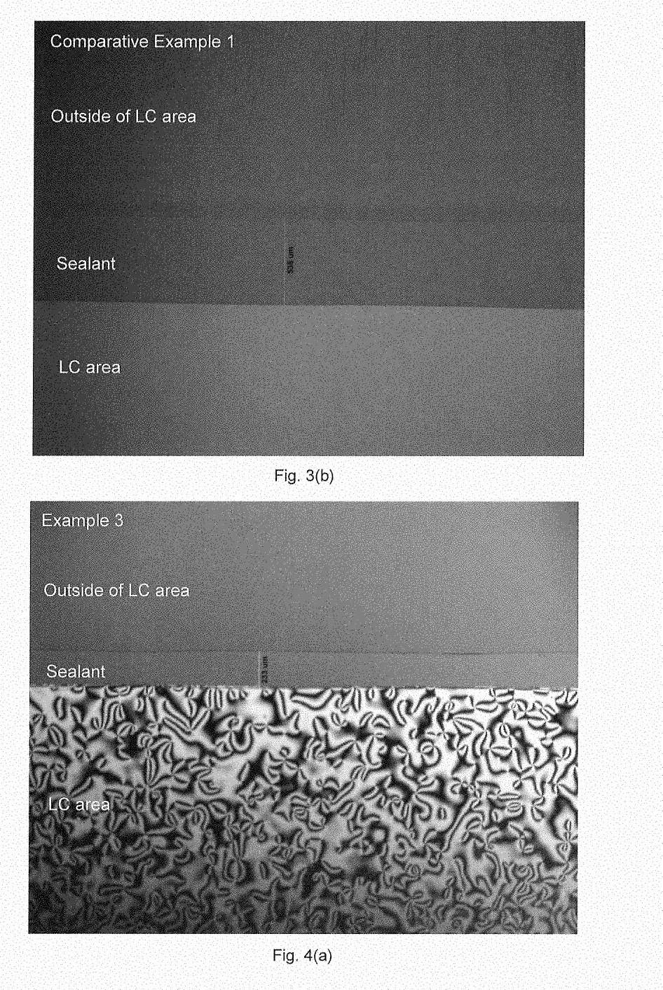

The LC penetration test result was evaluated as “Good” if no LC penetration could be observed after the two-stage UV curing, and the result was considered as “Poor” if LC penetration could be clearly observed. The images of Example 3 and Comparative Example 1 are shown in FIGS. 3(a) and (b). The test results are shown in Table 1.

### (3) LC Sealing Performance

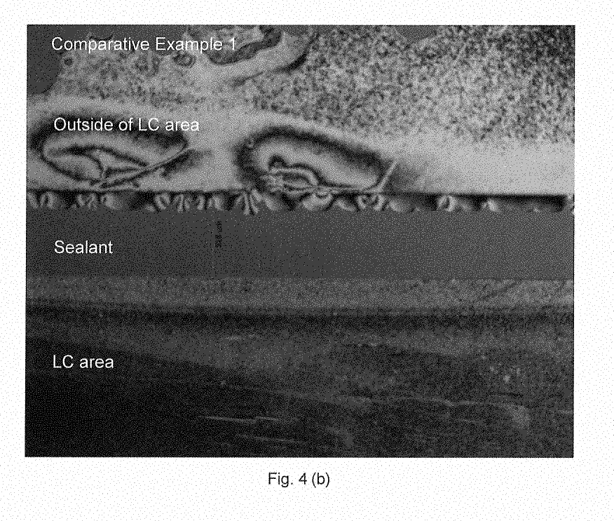

After the LC penetration test, all assembled cell samples were placed under room temperature and atmosphere conditions for 1 month, and then were observed by a microscope to check whether liquid crystal material went across the sealant and spread out of the sealing area. The images of Example 3 and Comparative Example 1 taken by using a polarizer to obtain clear images are shown in FIGS. 4(a) and (b). The test result was evaluated as “Good” if no LC could be observed in the outer area of the sealant borderline, and the result was considered as “Poor” if such out-spread of LC could be clearly observed. The test results are shown in Table 1.

As clearly in Table 1, all inventive examples were easily dispensed and surprisingly exhibited an excellent moisture resistance of the cured product by an ODF process even under severe conditions, which could not be achieved by the comparative examples containing typical bisphenol A epoxy resins as resin matrix. Meanwhile, as illustrated in FIG. 3(a), the sealant compositions of the inventive examples achieved a good LC penetration resistance in the ODF process. In addition, all inventive examples achieved an improved LC sealing performance over a long term than the comparative examples. As illustrated in FIGS. 4(a) and (b), the LC sealed by the sealant according to Example 3 still remained in the LC area (FIG. 4(a)) over 1 month after the sealing, but the sealant according to the comparative examples failed to seal the LC (FIG. 4(b)), which caused a leakage of LC to the outside of LC area.

TABLE 1
Formulations of cationically curable sealant compositions (in parts by weight) and test results

| | | | | | | | Comparative | Comparative |
|---|---|---|---|---|---|---|---|---|
| Component | Ex. 1 | Ex. 2 | Ex. 3 | Ex. 4 | Ex. 5 | Ex. 6 | Ex. 1 | Ex. 2 |
| EPALLOY 8250 | 100 | 80 | 50 | 50 | 50 | 50 | — | — |
| D.E.N. 438 | — | — | 50 | 50 | 50 | 50 | — | — |
| HP 7200 | — | 20 | — | — | — | — | — | — |
| YX8040 (Solid) | — | — | — | — | — | — | 15 | 36 |
| YX8034 (Liquid) | — | — | — | — | — | — | 85 | — |
| YX8000 (Liquid) | — | — | — | — | — | — | — | 64 |
| IRGACURE 250 | 0.2 | 1.0 | 1.0 | — | — | — | 2.0 | 2.0 |
| SilForce UV 9380 C | — | — | — | 1.0 | — | — | — | — |
| Rhodorsil 2074 | — | — | | — | 1.0 | — | — | — |
| PC-2506 | — | — | — | — | — | 0.2 | — | — |

Test results

| | | | | | | | | |
|---|---|---|---|---|---|---|---|---|
| Moisture resistance | Good | Good | Good | Good | Good | Good | Poor | Poor |
| LC penetration | Good | Good | Good | Good | Good | Good | Good | Good |
| resistance | | | | | | | | |
| LC sealing | Good | Good | Good | Good | Good | Good | Poor | Poor |
| performance | | | | | | | | |

What is claimed is:

1. A cationically curable sealant composition for liquid crystal sealing, comprising an epoxy resin selected from phenol novolac epoxy resin, dicyclopentadiene type epoxy resin, and combination thereof; and a diaryliodonium fluorine photoinitiator represented by formula (1), 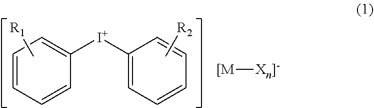
wherein R₁ and R₂ represent each independently hydrogen, an optionally substituted alkyl, an optionally substituted cycloalkyl, an optionally substituted alkoxy, or carboxyl or its ester, M represents As, P, Sb or B, X represents F or C₆F₅, and n is 4 or 6.

2. The cationically curable sealant composition according to claim 1, wherein the phenol novolac epoxy resin is represented by formula (2), 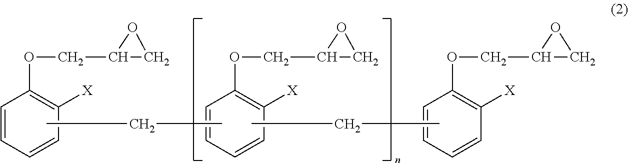
wherein X represents hydrogen or methyl, and n has an average value of 0.1 to 3.

3. The cationically curable sealant composition according to claim 1, wherein the phenol novolac epoxy resin has a number average molecular weight of 300 to 1,000 g/mol.

4. The cationically curable sealant composition according to claim 1, wherein the phenol novolac epoxy resin has a viscosity of 500 cps to 100,000 cps at 52° C.

5. The cationically curable sealant composition according to claim 1, wherein dicyclopentadiene type epoxy resin is represented by formula (3), 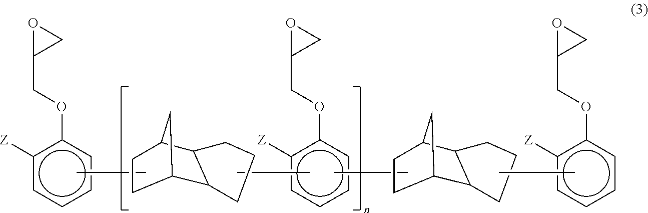
wherein Z represent hydrogen or a C₁₋₆ alkyl, and n has a value of 0 to 2.

6. The cationically curable sealant composition according to claim 1, wherein the sealant composition essentially comprises no bisphenol A epoxy resin.

7. The cationically curable sealant composition according to claim 1, wherein the diaryliodonium fluorine photoinitiator is present in an amount of 0.01 to 5 parts by weight based on 100 parts by weight of the total amount of curable composition.

8. A cured sealant product obtained from the cationically curable sealant composition according to claim 1.

9. The cured sealant product according to claim 8, wherein the cured sealant product has a water vapor transmission rate of 15 g/(m²·day) or less at 50° C. and 100% relative humidity.

10. A process of producing a liquid crystal display having a liquid crystal layer between a first substrate and a second substrate, comprising steps of:
a) applying the cationically curable sealant composition according to claim 1 on a sealing region at a periphery of a surface of the first substrate;
b) radiation curing the composition, and obtaining a partially cured product;
c) dropping liquid crystal on a central area encircled by the sealing region of the surface of the first substrate or the corresponding area of the second substrate, and forming the liquid crystal layer;
d) overlaying the second substrate on the first substrate; and
e) radiation curing the partially cured product.

11. The process of producing a liquid crystal display according to claim 10, in which the radiation curing in step b) is ultraviolent curing.

12. The process of producing a liquid crystal display according to claim 10, in which in step b), the ultraviolet radiation applied to the cationically curable sealant composition has a radiation energy of less than 3,000 mJ/cm².
